(19) United States
(12) Patent Application Publication
(10) Pub. No.: US 2018/0202572 A1
(43) Pub. Date: Jul. 19, 2018

(54) HIGH POWER DENSITY SOLENOID ACTUATOR

(71) Applicant: BorgWarner Inc., Auburn Hills, MI (US)

(72) Inventor: Jeffrey J. WATERSTREDT, Royal Oak, MI (US)

(21) Appl. No.: 15/744,097

(22) PCT Filed: Jul. 13, 2015
(86) PCT No.: PCT/US2015/040132

§ 371 Date: Jan. 12, 2018

(51) Int. Cl. F16K 31/06; F16H 61/02; H01F 7/16

(52) U.S. Cl. CPC F16K 31/0613; F16H 61/0251; H01F 2007/085; H01F 7/1607; F16H 2061/0253; F16K 31/0675

(57) ABSTRACT

A solenoid actuator is provided including, a flux return tube, a pole piece having a pole piece shunt, and an armature assembly having a magnetic portion and a non-magnetic spacer. The solenoid actuator also includes two non-magnetic bearing strips for the armature assembly, wherein one of the bearing strip slides on the flux return tube, and a second bearing strip slides on the pole piece shunt.

### FIELD OF THE INVENTION

The present invention relates to solenoid actuators. More particularly the field of the present invention relates to solenoid actuators useful in automotive vehicle applications.

### BACKGROUND OF THE INVENTION

In the chronicles of solenoid actuator design, there is a constant quest to maximize efficiency (sometimes referred to as power density) by reducing the weight of the solenoid actuator, or maximizing the force output of the solenoid actuator, or minimizing the electric current required to power the solenoid actuator. Solenoid actuators typically have a casing, a flux return (often referred to as a flux tube) magnetically joined to the casing and a pole piece magnetically separated from the flux return by a flux choke. Slidably mounted inside the flux return and pole piece is it magnetic armature. Ideally, a radial clearance between the armature, the flux choke, and pole piece should be large enough to allow the armature to freely move but small as possible to maximize magnetic efficiency.

An example of a solenoid actuator utilized in a solenoid valve is shown in U.S. patent application Ser. No. 14/408,044 (Mills, et al, hereinafter “Mills), published May 28, 2015 as U.S. Patent Publication No. 2015/0144820, the disclosure of which is incorporated by reference herein.

Mills discloses a solenoid valve 7 having can have a ferromagnetic casing 10. The casing 10 along its lower end has a series of slots (not shown) to aid in their bending over of tabs 12 which contact an inclined portion 14 of a hydraulic body 16 to capture the same to the casing 10 and to a flux washer or pole piece 18. The casing 10 is generally open along its lower end and is closed on its top end 20. The casing 10 forms a generally tubular envelope. The casing 10 may be machined, deep drawn, or forged. Positioned within the casing and extending generally axially therein is a first ferromagnetic annular member commonly referred to as the flux return or flux tube 22. The flux tube 22 is radially aligned by a non-magnetic alignment tube 24 with a second ferromagnetic annular magnetic member commonly referred to as a pole piece shunt 26. The pole piece shunt 26 is magnetically connected with the casing by the integral pole piece 18. The pole piece 18 contacts the hydraulic body along an axial interface 80. Axially magnetically separating the flux tube 22 from the pole piece shunt 26 is a gap 28. Radially juxtaposing the flux tube 22 and pole piece shunt 26 from the casing 10 is a coil and bobbin assembly 30. The coil and bobbin assembly includes a non-magnetic typically polymeric bobbin 32 that is wrapped by a copper coil bundle 34. The coil 34 is electrically actuated to activate movement of a ferromagnetic armature 36. An electrical connector 35 is provided to provide current to the coil 34.

The ferromagnetic armature 36 is slidably mounted within the flux tube 22 and the pole piece 26. The top end 20 of the casing has extending internally downward there from a dimple 42 to aid in the prevention of magnetic latching of the armature 36 with the casing 10. The armature 36 or alternatively the flux tube 22 and pole piece 26 may have a thin lining of non-magnetic material such as nickel or other non-magnetic compounds to aid in the prevention of side latching. The armature 36 also has a series of axial passages 46 to allow fluid within the solenoid valve 7 to move between axial sides of the armature 36. The armature 36 imparts movement to a valve member 50 via a ball 52 connected with the armature 36.

The hydraulic body 16 has an exhaust inlet/outlet passage provided by a cross bore 56. A cross-bore 58 is connected with the supply pressure. An axial bore 60 is connected with control pressure. As shown, solenoid 7 is a normally low control pressure solenoid valve. Hydraulic body 16 is a polymeric member having a metallic inner liner or sleeve 64. Slidably mounted within the sleeve is the valve member 50 having a spool portion 66. The spool portion 66 is spring biased by a spring 68 which engages a washer 70. The spool 66 has an internal passage 72 which is connected with the control pressure which intersects a series of cross bores 74. Cross bores 74 are typically positioned wherein they fluidly communicate with cross bore 56 bringing control pressure in communication with exhaust. To cause control pressure to be connected with supply pressure, coil 34 is actuated causing the armature 36 to move against the biasing of spring 68 causing cross bores 74 to be brought in fluid communication with the hydraulic body cross bore 58 which is connected with fluid supply to increase the hydraulic pressure in the system. The activation of the coils 34 generating a flux loop in the pole piece, casing, and flux tube. Due to the gap 28, the flux loop will skip into the armature 36 and then exit out through the armature to the pole piece shunt 26 causing the armature 36 to reach a point of least reluctance thereby causing the armature 36 to move downward.

As mentioned previously the armature can be nickel plated to minimize the non-working air-gaps of a solenoid magnet design to improve solenoid efficiency and increasing the solenoid power density. A great deal of effort in design and manufacturing is taken to align the centerlines of the pole piece and flux tube to minimize the eccentricity of the armature to the pole piece shunt. Any eccentricity contributes negatively to the sliding friction of the solenoid, as magnetic side-loading is very sensitive to the eccentricity. In addition, the nominal radial clearance between the armature and pole piece shunt is designed to be large to keep magnetic side-loading under control in light of less than perfect alignment and eccentricity.

In a subsequent generation of solenoid actuators 17 (FIG. 2), a one-piece core design is provided where the flux return tube 19 and pole piece shunt 21 are manufactured as one piece of steel 23 with a thin “flux bridge” 25 connecting the two. By manufacturing the component this way, near-perfect eccentricity is achieved and the nominal clearance between the armature 37 and the pole piece shunt 21 is reduced to improve the magnetic efficiency of the solenoid actuator 17. However, some of this improved efficiency is offset by a loss of efficiency due to the magnetic short-circuiting through the introduced “flux bridge”.

It is desirable to have the best of both worlds: low radial clearances and no short-circuit between flux return and pole piece shunt.

### SUMMARY OF THE INVENTION

To make manifest the above noted and other desires, a revelation of the present invention is brought forth. The present invention endows a freedom of solenoid actuator wherein a flux return tube and a pole piece shunt are axially separate but aligned either through a non-magnetic component directly, through the magnetic housing or by some other means. The above-noted arrangement accomplishes good, though not perfect alignment. An inventive magnetic steel armature is combined with a non-magnetic spacer at the end of the armature proximate to the pole piece shunt. The armature and spacer could be combined through press-fit, welding, or sintering process. A non-magnetic or semi-magnetic bearing material is then added to the armature spacer assembly (herein after referred to as the armature assembly) to form two bearing surfaces at each end of the armature assembly. In a preferred embodiment, a non-magnetic composite coating is applied in two narrow strips to the armature assembly outside diameter. One strip is located at the end as far from the pole piece shunt as possible and will slide on the flux return tube inside diameter, acting as a first bearing. A second strip is applied to the armature assembly at the end closest to the pole piece shunt as possible. This second non-magnetic composite coating strip is applied at least partially over the spacer itself and acts as a second bearing.

The advantage of the above noted construction is that the magnetic portion of the armature assembly can stroke completely out of the pole piece shunt while the spacer with composite coating bearing strip remains inside the pole piece shunt and maintains sliding contact and alignment. Prior to the present invention, it was not possible to use the pole piece shunt as a second bearing unless it was integrated with the flux return tube and “flux bridge” to support the armature as it stroked out of the pole piece shunt.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a solenoid actuator prior to the present invention;

FIG. 2 is a sectional view of another solenoid actuator prior to the present invention;

FIG. 3 is a sectional view of a solenoid actuator according to the present invention;

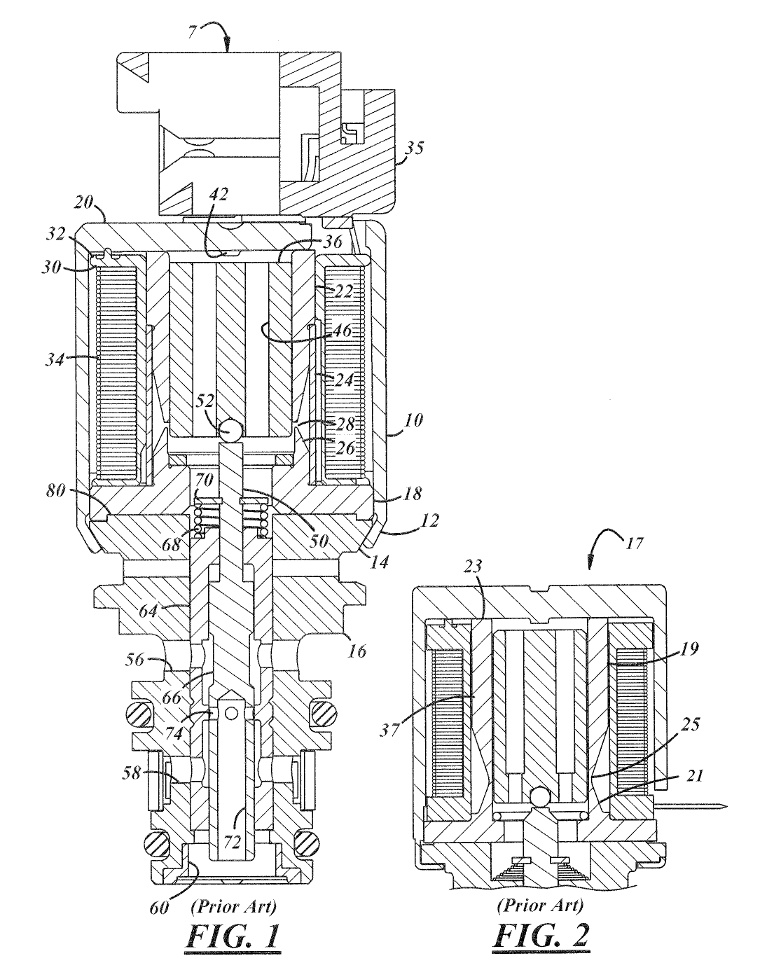

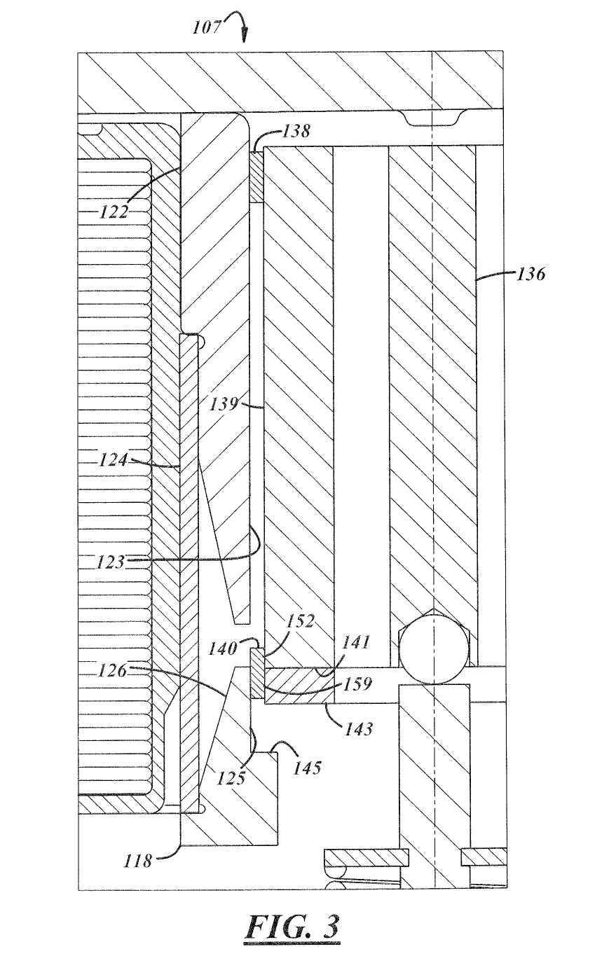

### DETAILED DESCRIPTION OF THE PREFERRED EMBODIMENTS

The following description of the preferred embodiment(s) is merely exemplary in nature and is in no way intended to limit the invention, its application, or uses.

Referring to FIG. 3, a solenoid actuator 107 according to the present invention is provided. The solenoid actuator 107 has a flux tube 122 that is magnetically connected to the casing 110. The flux tube 122 is axially separated and aligned through a non-magnetic alignment tube 124 or by some other means with the pole piece 126 shunt. The pole piece shunt 126 has inner diameter 125 within 0.40 mm of an inner diameter 123 of the flux tube 122. The flux tube 122 and the pole piece shunt 126 are aligned to have centerlines between within 0.05 mm concentricity.

An armature assembly 136 is provided slidably mounted within the flux tube 122 and pole piece shunt 126. The armature assembly 136 has a soft magnetic steel portion 139. On a lower axial face 141 of the armature magnetic portion there is provided a non-magnetic spacer 143. The non-magnetic spacer 143 prevents magnetic latching between the armature and an axial flat 145 of the pole piece 118. The armature magnetic steel portion 139 and non-magnetic spacer 143 may be combined through an adhesive, welding, or sintering process. In an embodiment not shown the non-magnetic spacer can have an inner hub (or outer rim) that extends into (or over) an axial bore (or axial outer groove) of the magnetic portion and is press fitted therein (thereon).

The armature assembly 136 has upper 138 and lower 140 bearings provided by two non-magnetic bearing strips. The bearing strips 138, 140 are typically fabricated from a non-magnetic composite and or non-magnetic polymeric material. A first bearing strip 138 slides on the flux tube 122 and is typically located at an extreme far end away from the pole piece shunt 126. A second bearing strip 140 is applied to the armature assembly 136 at an end of the armature assembly closest to the pole piece unit 126 as possible. The second non-magnetic composite bearing strip 140 is applied at least partially over the non-magnetic spacer 146. As shown the second bearing strip has a portion 152 that is also joined to the armature assembly magnetic portion 139. It is typically preferable that the armature magnetic portion 139 and non-magnetic spacer 143 have a common outer diameter. The non-magnetic spacer 143 typically has an axial length of 0.6 mm or greater. The portion 159 of the bearing strip 140 connected on the non-magnetic spacer is preferably at least 0.5 mm in axial length. When the armature assembly is at an extreme position away from the pole piece shunt 126 (the armature assembly 136 being displaced slightly upward from its position as shown in FIG. 3) it is preferable that the armature magnetic portion 139 not be axially penetrating of the pole piece shunt 126. At the aforementioned extreme position the portion of the lower bearing strip 154 connected to the non-magnetic spacer 143 provides the bearing for the bearing assembly 136.

The description of the invention is merely exemplary in nature and, thus, variations that do not depart from the gist of the invention are intended to be within the scope of the invention. Such variations are not to be regarded as a departure from the spirit and scope of the invention.

1. A solenoid actuator comprising:
a flux return tube;
a pole piece including a pole piece shunt with an inside diameter within 0.40 mm of said flux return tube inside diameter and wherein said pole piece shunt and said flux return tube are aligned in an axially separated assembly to have centerlines within 0.05 mm concentricity;
an armature assembly, said armature assembly including a soft magnetic portion and a non-magnetic spacer, and
two non-magnetic bearing strips connected on said armature assembly, said bearing strips having a thickness of 0.025-0.100 mm, wherein one of said bearing strip slides on said flux return tube, and a second of said bearing strips slides on said pole piece shunt and is connected on said non-magnetic spacer.

2. The solenoid actuator of claim 1 wherein at least one of said bearing strips is made from a polymeric material.

3. The solenoid actuator of claim 1 wherein said second bearing strip is also connected on said magnetic portion of said armature.

4. The solenoid actuator of claim 1 wherein said magnetic portion of said armature assembly does not penetrate said pole piece shunt when said armature assembly is at an extreme position away from said pole piece.

5. The solenoid actuator of claim 1 wherein said armature assembly magnetic portion and said armature assembly non-magnetic spacer have a common outer diameter.

6. The solenoid actuator of claim 1 wherein said second bearing strip has an axial length on said non-magnetic spacer of at least 0.5 mm.

7. The solenoid actuator of claim 1 wherein said non-magnetic spacer has an axial length of at least 0.6 mm.

8. The solenoid actuator of claim 1 wherein said first spacer is connected on an extreme end of said magnetic portion of said armature assembly away from said pole piece.

9. The solenoid actuator of claim 1 wherein said armature assembly magnetic portion if fabricated from a low carbon steel.

10. A solenoid actuator comprising:
a flux return tube;
a pole piece including a pole piece shunt with an inside diameter within 0.40 mm of said flux return tube inside diameter and wherein said pole piece shunt and said flux return tube are aligned in an axially separated assembly to have centerlines within 0.05 mm concentricity;
an armature assembly, said armature assembly including a soft magnetic portion and a non-magnetic spacer, and
two non-magnetic polymeric bearing strips connected on said armature assembly, said bearing strips having a thickness of 0.025-0.100 mm, wherein one of said bearing strip slides on said flux return tube, and a second of said bearing strips slides on said pole piece shunt and is connected on said non-magnetic spacer and said armature assembly magnetic portion and wherein said magnetic portion of said armature assembly does not penetrate said pole piece shun when the armature assembly is at an extreme position away from said pole piece.

11. A solenoid actuator comprising:
a flux return tube;
a pole piece including a pole piece shunt with an inside diameter within 0.40 mm of said flux return tube inside diameter and wherein said pole piece shunt and said flux return tube are aligned in an axially separated assembly by a non-magnetic alignment tube to have centerlines within 0.05 mm concentricity;
an armature assembly, said armature assembly including a steel soft magnetic portion and a non-magnetic spacer, and
two non-magnetic polymeric bearing strips connected on said armature assembly, said bearing strips having a thickness of 0.025-0.100 mm, wherein one of said bearing strip slides on said flux return tube, and a second of said bearing strips slides on said pole piece shunt and is connected on said non-magnetic spacer and said armature assembly magnetic portion, said non-magnetic spacer having an axial length of at least 0.6 mm and wherein said second bearing strip has an axial length on said non-magnetic spacer of at least 0.5 mm, and wherein said magnetic portion of said armature assembly does not penetrate said pole piece shunt when said armature assembly is at an extreme position away from said pole piece.
